(19) United States
(12) Patent Application Publication
(10) Pub. No.: US 2010/0021163 A1
(43) Pub. Date: Jan. 28, 2010

(54) METHOD AND SYSTEM FOR POLARIZATION SUPPORTED OPTICAL TRANSMISSION

(75) Inventor: William Shieh, Glen Waverley (AU)

Correspondence Address: KENYON & KENYON LLP, RIVERPARK TOWERS, SUITE 600, 333 W. SAN CARLOS ST., SAN JOSE, CA, 95110, US

(73) Assignee: THE UNIVERSITY OF MELBOURNE, Parkville (AU)

(21) Appl. No.: 12/509,371

(22) Filed: Jul. 24, 2009

Related U.S. Application Data
(60) Provisional application No. 61/083,237, filed on Jul. 24, 2008.

(51) Int. Cl. H04J 14/06

(52) U.S. Cl. 398/65

(57) ABSTRACT

A method comprising splitting a received optical signal into split optical signals, the split optical signals being at least initially orthogonally polarized, coherently detecting at least one of the split optical signals and generating an electrical signal indicative thereof, and processing said electrical signal, the processing being adapted for received optical signals with orthogonal frequency division multiplexing (OFDM) modulation. A transmission system, a transmitter and a receiver are also provided.

### FIELD OF THE INVENTION

The present invention generally relates to optical communications, and particularly but not exclusively to optical signal generation and detection.

### BACKGROUND OF THE INVENTION

Optical fibers (and other optical waveguides) typically support two polarization modes. The propagation of an optical signal along an optical fiber is influenced by polarization effects including polarization mode dispersion (PMD), coupling (PMC) and loss (PDL), as well as chromatic dispersion (CD). All of these are barriers to high-speed optical transmission. For conventional direct-detection single-carrier systems, the impairment induced by a constant differential-group-delay (DGD), a type of PMD, scales with the square of the bit rate, resulting in drastic PMD degradation for high speed transmission systems.

While progress has been made in realising 100 Gbit/s optical transmission using modulation formats and associated technologies such as Quadrature Phase Shift Keying (QPSK), QPSK and similar formats and technologies are not expected to be able to operate much beyond 100 Gbit/s.

### SUMMARY OF THE INVENTION

According to a first broad aspect of the present invention, there is provided a method comprising:

splitting a received optical signal into split optical signals, the split optical signals being at least initially orthogonally polarized;

coherently detecting at least one of the split optical signals and generating an electrical signal indicative thereof; and

processing the electrical signal, the processing being adapted for received optical signals with orthogonal frequency division multiplexing (OFDM) modulation.

In one embodiment, the method includes coherently detecting a plurality of the split optical signals and generating respective electrical signals indicative thereof, and processing the electrical signals.

The method may include processing all of the electrical signals, the processing being adapted for received optical signals with OFDM modulation.

Advantageously, in one embodiment the method comprises compensating for polarisation effects, for example PMD and PDL, without dynamic physical compensation. In this embodiment, processing of the electrical signals comprises processing of the electrical signals to achieve at least partial compensation of a polarisation effect that has degraded the optical signal before it was received. Processing the electrical signals may comprise constructing a Jones vector of a received OFDM symbol. The method may comprise determining an estimated Jones matrix. The method may comprise rotating the Jones vector by the Jones matrix. The method may comprise demapping each element of the Jones vector into a respective digital bit. The compensation may be substantially complete. The processing may be performed using one or more electrical circuits.

Advantageously, effective compensation of polarisation effects may allow polarisation multiplexing roughly doubling capacity.

In one embodiment, splitting the received optical signal comprises splitting the received optical signal into at least initially linearly polarized optical signals.

In an embodiment, the optical signal does not have an optical carrier tone.

In a particular embodiment, coherently detecting one or more of the split optical signals comprises combining each of the split optical signals with a coherent light and detecting the combination with a photodetector.

In some embodiments, processing at least one electrical signal comprises identifying the start of an OFDM symbol. In such embodiments, identifying the start of an OFDM symbol may comprise fast Fourier transform (FFT) window synchronization.

Processing at least one electrical signal may comprise down-conversion of at least one of the electrical signals to a base-band signal. In such embodiments, down-conversion may comprise exploiting a complex pilot subcarrier or residual carrier tone. The down-conversion may be done at least in part in software.

Processing at least one electrical signal may comprise phase estimation of an OFDM symbol.

Processing at least one of the electrical signals may comprise channel estimation, which may comprise exploiting a Jones vector and a Jones matrix.

The method may further comprise a preliminary step of generating the received optical signal, the optical signal having OFDM modulation.

According to a second broad aspect of the invention, there is provided a method comprising:

generating a pair of optical signals, each of the optical signals having Orthogonal Frequency Division Multiplexing (OFDM) modulation; and

combining the pair of optical signals in a polarization domain.

In an embodiment, each of the pair of optical signals comprise different data.

The modulation may be performed by an optical I/Q-modulator (such as comprising one or more Mach-Zenhder Modulators) biased at null, driven by a complex Orthogonal Frequency Division Multiplexing (OFDM) modulation signal.

In an embodiment, the optical signal does not have an optical carrier tone.

According to a third broad aspect of the invention, there is provided a receiver comprising:

a polarization splitter for splitting a received optical signal into split optical signals, the split optical signals being at least initially orthogonally polarized;

one or more coherent optical detectors for coherently detecting at least one of the split optical signals and generating an electrical signal indicative thereof; and

a processor for processing the electrical signal, the processing being adapted for received optical signals with Orthogonal Frequency Division Multiplexing (OFDM) modulation.

The polarization splitter may be arranged to split the received optical signal into at least initially linearly polarized optical signals.

The one or more coherent optical detectors may comprise:

a combiner for combining one of the split optical signals with a coherent light; and

a photo-detector (such as a photodiode) for detecting the combination.

The receiver may comprise an optical 90° hybrid, a local coherent light source (such as a laser source), and a plurality of single-ended or balanced photo-detectors.

The processor may be arranged to identify the start of an OFDM symbol.

The processor may be arranged to down-convert the electrical signal to a base-band signal.

The processor may be arranged for phase estimation for an OFDM symbol.

The processor may be arranged for channel estimation of at least one electrical signal.

The processor may be arranged to exploit a Jones vector and a Jones matrix.

In an embodiment, the processor may have a Jones vector receiver unit for receiving an OFDM symbol in the form of the Jones vector. The processor may have a estimated Jones matrix determiner unit for determining an estimated Jones matrix. The processor may have a Jones vector rotator unit for rotating the Jones vector by the Jones matrix. The processor may have a demapper unit for demapping each element of the Jones vector into a respective digital bit. Some or all of the units may be physically distinct. Alternatively, these functions may be achieved by programming a suitable processor to perform each function.

The processor may be arranged for segmenting the baseband signal into blocks.

The processor may be arranged for removing a cyclic prefix.

The processor may be arranged to exploit a fast Fourier transform to recover an individual subcarrier symbol in each OFDM symbol.

According to a fourth broad aspect of the invention, there is provided a transmitter comprising:

a generator for generating a plurality of optical signals, each of the optical signals having Orthogonal Frequency Division Multiplexing (OFDM) modulation; and

a combiner for combining the plurality of optical signals.

According to a fifth broad aspect of the invention, there is provided a transmission system comprising a transmitter as described above and a receiver as described above.

According to a sixth broad aspect of the invention, there is provided a transmission system comprising a generator for generating an optical signal having Orthogonal Frequency Division Multiplexing (OFDM) modulation, and a receiver as described above.

### BRIEF DESCRIPTION OF THE FIGURES

In order that the present invention may be better understood, embodiments will now be described, by way of example only, with reference to the accompanying figures in which:

FIG. 1 is a schematic view of an optical transmission system according to an embodiment of the invention;

FIG. 2 is a flow diagram of a method implemented by the receiver of the optical transmission system of FIG. 1;

FIG. 3 is a view of the receiver of the system of FIG. 1;

FIG. 4 is a view of the processor of the system of FIG. 1;

FIG. 5 is a block diagram of the units of one embodiment of a processor.

FIG. 6 is a view of the transmitter of the system of FIG. 1;

FIG. 7 is a flow diagram of the steps performed by the transmitter of FIG. 6;

FIG. 8 is a schematic view of an example of a coherent optical MIMO OFDM, single-input single-output (SISO) according to the present invention;

FIG. 9 is a schematic view of another example of a coherent optical MIMO OFDM, single-input two-output (SITO) according to the present invention;

FIG. 10 is a schematic view of yet another example of a coherent optical MIMO OFDM, two-input single-output (TISO) according to the present invention;

FIG. 11 is a schematic view of still another example of a coherent optical MIMO OFDM, two-input two-output (TITO) according to the present invention;

FIG. 12 is a schematic of one embodiment of a polarization diversity receiver that may be used in the apparatus of FIG. 11;

FIG. 13 is a schematic diagram of an example of a transmitter according to the present invention of the systems of FIGS. 1, 6 and 8 to 11;

FIG. 14 is a schematic view of another embodiment of a transmission system according to the present invention;

FIGS. 15 and 16 show example RF spectra for two polarization components;

FIG. 17 is the overall RF spectra corresponding to the RF spectra of FIGS. 15 and 16;

FIG. 18 shows an example BER performance of a signal;

FIG. 19 shows an example BER variation as a function of PMD state;

FIG. 20 shows an example result for system performance as a function of launch power; and

FIG. 21 shows an example result for system performance as a function of a non-linear coefficient.

In the figures, similar components are similarly numbered across the various embodiments.

### DETAILED DESCRIPTION OF EMBODIMENTS OF THE INVENTION

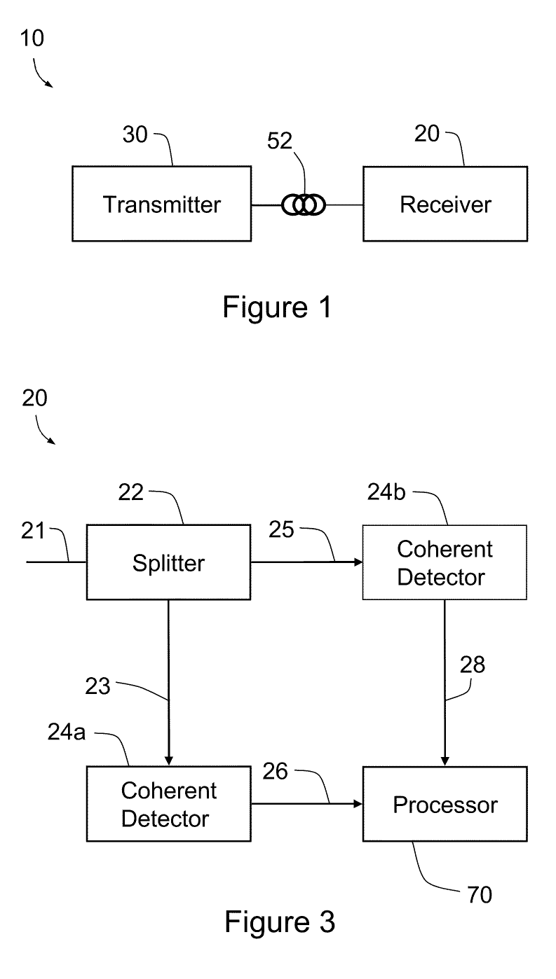

FIG. 1 is a schematic view of an optical transmission system generally indicated by the numeral 10. System 10 has an optical transmitter 30 and an optical receiver 20. Transmitter 30 and receiver 20 are connected by a waveguide such as an optical fiber 52. In some alternative embodiments some or all of optical fiber 52 may be replaced by free space propagation. Transmitter 30 generates optical signals having Orthogonal Frequency Division Multiplexing (OFDM) modulation. Typically each of the optical signals does not have an optical carrier tone. The signals travel along fiber 52 and are subsequently received by receiver 20. System 10 uses coherent detection, so the transmission scheme used is referred to herein as coherent OFDM (CO-OFDM).

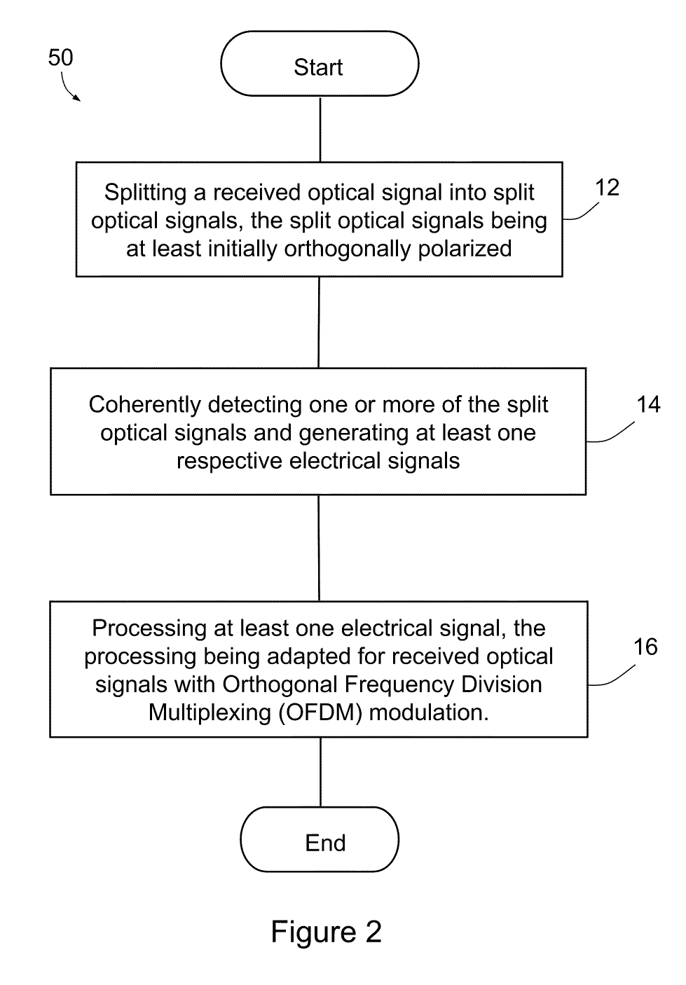

FIG. 2 is a flow diagram of a method 50 implemented by receiver 20. Method 50 provides detection of the optical signal having OFDM modulation. In this embodiment, method 50 provides resilience against polarization, chromatic and nonlinear effects in optical fiber 52, which degrade the optical signal. Polarization-supported transmission has two attributes: (i) resilience to PMD; and (ii) the absence of an optical polarization tracking device before the receiver. The terms ‘polarization-supported’ and the two aforementioned attributes are hence used interchangeably.

One example of receiver 20 is shown in FIG. 3. In this example, receiver 20 comprises a polarization splitter 22, first and second coherent detectors 24a,24b and a processor 70. An optical signal 21 that has traversed optical fiber 52, for example, is received by polarization splitter 22 and split by polarization splitter 22 into split optical signals 23,25, the split optical signals being initially orthogonally polarized. This corresponds to method step 12 (above). Split optical signals 23,25 are then transmitted along further optical waveguides (not shown) to respective detectors 24a,24b. It will be appreciated that the polarizations of split optical signals 23,25 should not be significantly changed after the point of splitting, but any such changes do not affect the operation of system 10.

Thus, at least one but typically both of split optical signals 23,25 are transported by waveguide or bulk optics to a respective coherent detector 24a,24b, coherently detected, and a respective electrical signals 26,28 are generated by respective coherent detectors 24a,24b in response thereto (cf. method step 14 of FIG. 2). In one embodiment, coherent detectors 24a,24b are provided in the form of a photo diode, and coherent detection of split optical signals 23,25 is effected by combining split signals 23,25 with coherent light, such as that generated by an external cavity diode laser or a distributed feedback laser, and then detecting the combination with the photo diode.

At least one electrical signal 26,28 is processed by processor 70 adapted for received optical signals with OFDM modulation (cf. method step 16 of FIG. 2).

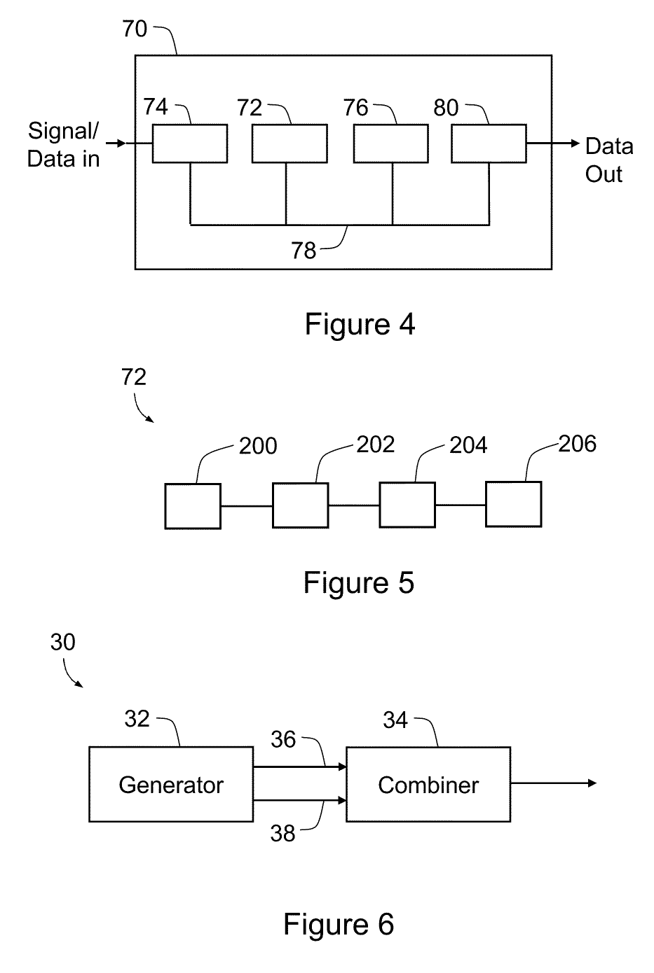

As shown schematically in FIG. 4, in this embodiment the processor 70 includes a central processing unit 72, one or more coherent detector interfaces 74, a memory 76 holding software instructions for the central processor, an output interface 80 and one or more buses 78 connecting these. Memory 76 of this embodiment comprises one or more of: CPU registers, on-die SRAM caches, external caches, DRAM and/or, paging systems, virtual memory or swap space on the hard drive, or any other type of memory. However, embodiments may have additional or less memory types as suitable.

Processing 16 the electrical signals 23,25, in this embodiment, comprises:

identifying the start of an OFDM signal, or fast Fourier transform (FFT) window synchronization using a Schmidl format;

down converting at least one of electrical signals 26,28 to a base band signal;

exploiting a complex pilot subcarrier or residual carrier tone, wherein the down conversion is done in software;

phase estimating an OFDM symbol;

using channel estimation on the respective electrical signals, the channel estimation transfer function being represented by a Jones matrix;

segmenting the base band signal into blocks and then removing a cyclic prefix; and

recovering an individual sub-carrier symbol in an OFDM symbol by exploiting a fast Fourier transform.

The received Jones vector is rotated by the estimated Jones matrix to obtain the transmitted Jones vector. Each element of the Jones vector is subsequently de-mapped into the transmitted digital bits.

As shown in FIG. 5, the central processing unit 72 of this embodiment has interacting sub units. In this embodiment, processing unit 72 has a Jones vector receiver unit 200 for receiving an OFDM symbol in the form of the Jones vector, an estimated Jones matrix determiner unit 202 for determining an estimated Jones matrix, a Jones vector rotator unit 204 for rotating the Jones vector by the Jones matrix, and a demapper unit 206 for demapping each element of the Jones vector into a respective digital bit. Each unit 200, 202, 204, 206 processes information input into it and passes its processed output into the next unit, except unit 206. For example, the output of unit 200 is the input of 202. In this embodiment each unit is distinct and comprises speciality circuitry optimised to achieve its function. However it will be appreciated that some or all of these units may be integrated into one or more larger units in other embodiments. In some embodiments, one or more of the units are achieved by programming a suitable high speed processor.

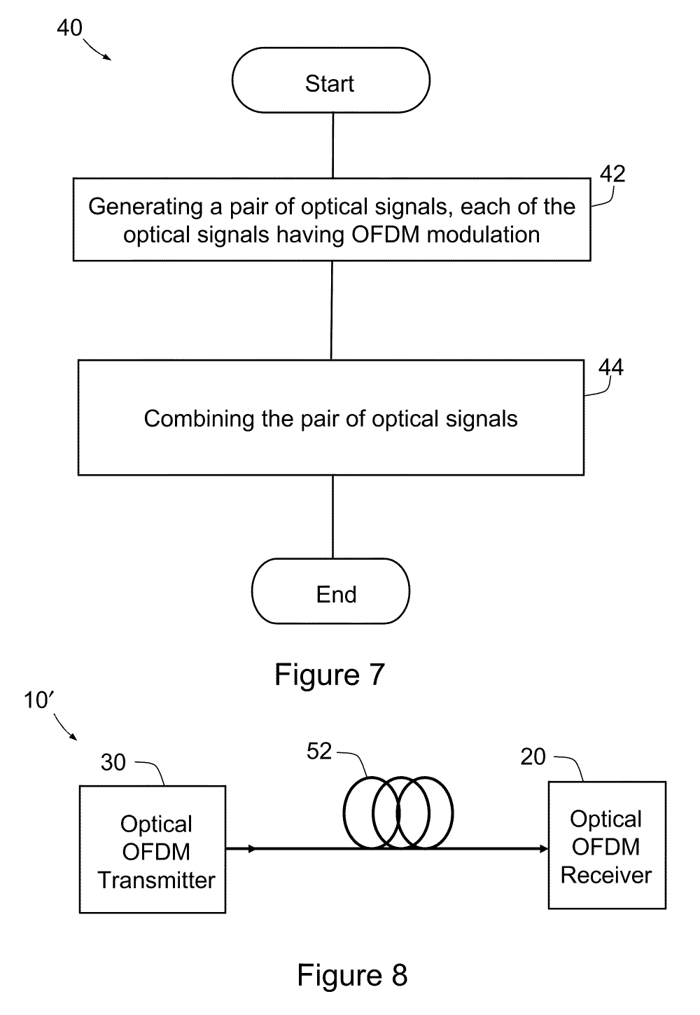

FIG. 6 is a view of transmitter 30, arranged to perform the steps shown in the flow diagram of FIG. 7. Transmitter 30 includes an optical generator 32 for generating 42 a pair of optical signals 36,38, each having OFDM modulation. Optical generator 32 may comprise laser diodes, such as DFB laser diodes. Transmitter 30 also comprises a combiner 34 for combining optical signals 36,38. Generator 32 generates a pair of orthogonally polarized optical signals and combiner 34 is arranged to combine these two orthogonally polarized signals without losing either signal's polarization. Combiner 34 could be, for example, a polarizing beam splitter cube 34. In some embodiments, however, generator 32 generates only one OFDM modulated optical signal 36, in which case combiner 34 is not required and the steps of FIG. 7 would be suitably modified, including omitting step 44.

Without wishing to be bound by any theory it is suggested that the following models for an optical fiber communication channel in the presence of polarization effects help explain the operation of the embodiments described above.

The transmitted Orthogonal Frequency Division Multiplexing (OFDM) time-domain signal, s(t) is described using Jones vector given by

$$\begin{matrix}s ( t ) = {\sum }_{i = - ∞}^{+ ∞} {\sum }_{k = - \frac{1}{2} {N}_{sc} + 1}^{\frac{1}{2} {N}_{sc}} {\vec{c}}_{ik} Π ( t - {iT}_{s} ) exp ( j 2 π {f}_{k} ( t - {iT}_{s} ) ) & ( 1 ) \\ s ( t ) = ( \begin{matrix}{s}_{x} \\ {s}_{y}\end{matrix} ) , {\vec{c}}_{ik} = ( \begin{matrix}{c}_{ik}^{x} \\ {c}_{ik}^{y}\end{matrix} ) & ( 2 ) \\ {f}_{k} = \frac{k - 1}{{t}_{s}} & ( 3 ) \\ Π ( t ) = \{ \begin{matrix}1 , & ( - {Δ}_{G} < t \leq {t}_{S} ) \\ 0 , & ( t \leq - {Δ}_{G} , t > {t}_{S} )\end{matrix} & ( 4 )\end{matrix}$$

where sₓ and s_{y} are the two polarization components for s(t) in the time-domain, \vec{c}ᵢₖ is the transmitted OFDM information symbol in the form of Jones vector for the kth subcarrier in the ith OFDM symbol, cᵢₖ^{x} and cᵢₖ^{y} are the two polarization components for \vec{c}ᵢₖ, fₖ is the frequency for the kth subcarrier, N_{sc} is the number of OFDM subcarriers, Tₐ, Δ_{G}, and tₛ are the OFDM symbol period, guard interval length and observation period respectively. The Jones vector \vec{c}ᵢₖ is employed to describe generic OFDM information symbol regardless of any polarization configuration for the OFDM transmitter. In particular, the \vec{c}ᵢₖ encompasses various modes of the polarization generation including single-polarization, polarization multiplexing and polarization-modulation, as they all can be represented by a two-element Jones vector \vec{c}ᵢₖ. The different scheme of polarization modulation for the transmitted information symbol is automatically dealt with in initialization a phase of OFDM signal processing by sending known training symbols.

A guard interval is selected to be long-enough to handle the fiber dispersion including PMD and CD. This timing margin condition is given by

$$\frac{c}{{f}^{2}} \vert {D}_{t} \vert \cdot {N}_{SC} \cdot Δ f + D G {D}_{max} \leq {Δ}_{G} \qquad ( 5 )$$

where f is the frequency of the optical carrier, c is the speed of light, Dₜ is the total accumulated chromatic dispersion in units of ps/pm, Nsc is the number of the subcarriers, Δf is the subcarrier channel spacing, and DGDₘₐₓ is the maximum budgeted differential-group-delay (DGD), which is about 3.5 times of the mean PMD to have sufficient margin.

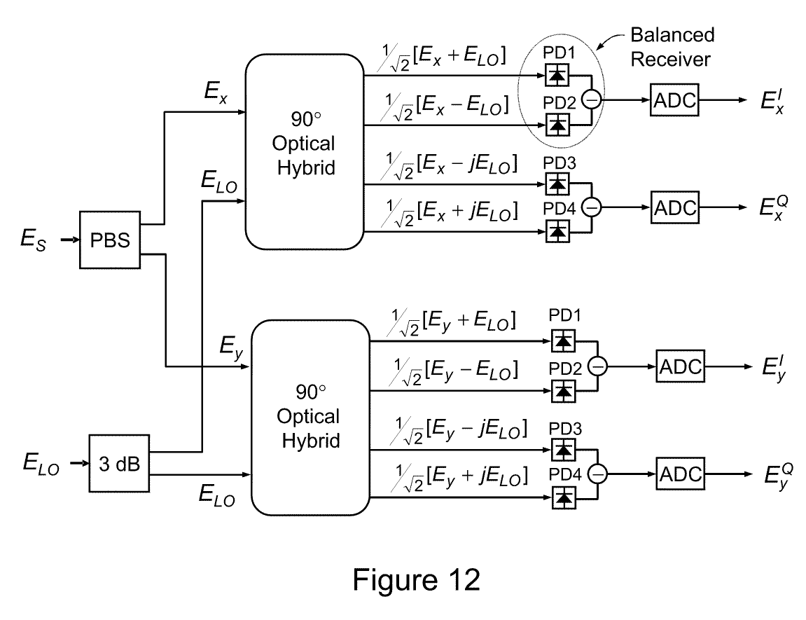

An example of the polarization diversity receiver is shown in FIG. 12, which includes a 3 dB coupler (3 dB), a polarization beam splitter, two 90° optical hybrids, a plurality of photo detectors (PD) and a plurality of analogue-to-digital polarization converters (ADC). In this figure, Eₛ is the Incoming Signal, E_{LO} is the Local Oscillator Signal The purpose of the coherent receiver is to linearly down-convert the OFDM signal from optical domain to electrical domain. The flow of the coherent detection is as follows: the incoming signal is split into x and y polarization components with the polarization beam splitter. Each polarization component is combined with 50% of the local oscillator signal with a respective 90° optical hybrid. The four outputs of each of the optical hybrids are partitioned into two groups for in-phase (I) and quadrature (Q) detection. The two ‘I’ and two ‘Q’ output ports are fed into respective pairs of balanced photodiodes, down converted to the electrical domain, and fed into high-speed analog-to-digital converters (ADC) for conversion to digital data for further signal processing. The received complex OFDM signal r(t) can be expressed as

$$r ( t ) = [ \begin{matrix}{E}_{x}^{I} + j {E}_{x}^{Q} \\ {E}_{y}^{I} + j {E}_{y}^{Q}\end{matrix} ] \qquad ( {5}^{′} )$$

The RF OFDM receiver signal processing involves (1) FFT window synchronization using Schmidl format to identify the start of the OFDM symbol, (2) software down-conversion of the OFDM RF signal to base-band by a complex pilot subcarrier tone, (3) removing cyclic prefix and partitioned into many OFDM symbols, (4) performing FFT to obtain the received symbols, which will be discussed in the next paragraph.

Assuming a long-enough symbol period, the received symbol is given by

$$\begin{matrix}{\vec{c}}_{ki}^{′} = {e}^{j {φ}_{i}} \cdot {e}^{{jΦ}_{D} ( {f}_{k} )} \cdot {T}_{k} \cdot {\vec{c}}_{ki} + {\vec{n}}_{ki} & ( 6 ) \\ {T}_{k} = {\prod }_{l = 1}^{N} exp \{ ( - \frac{1}{2} j \cdot {\vec{β}}_{l} \cdot {f}_{k} - \frac{1}{2} {\vec{α}}_{l} ) \cdot \vec{σ} \} & ( 7 ) \\ {Φ}_{D} ( {f}_{k} ) = π \cdot c \cdot {D}_{t} \cdot {f}_{k}^{2} / {f}_{LD 1}^{2} & ( 8 )\end{matrix}$$

where \vec{c}′ₖᵢ=(c′ₓ^{ki} c′_{y}^{ki})^{t} is the received information symbol in the form of the Jones vector for the kth subcarrier in the ith OFDM symbol, \vec{n}ₖᵢ=(nₓ^{ki} n_{y}^{ki})^{t} is the noise including two polarization components, Tₖ is the Jones matrix for the fiber link, N is the number of PMD/PDL cascading elements represented by their birefringence vector \vec{β}ₗ and PDL vector \vec{α}ₗ [i], \vec{σ} is the Pauli matrix vector, Φ_{D}(fₖ) is the phase dispersion owing to the fiber chromatic dispersion (CD), and φᵢ is the OFDM symbol phase noise owing to the phase noises from the lasers and RF local oscillators (LO) at both the transmitter and receiver. φᵢ is usually dominated by the laser phase noise.

Coherent Optical MIMO-OFDM Models

In the context of the multiple-input multiple-output (MIMO) system, the architecture of CO-OFDM system is divided into four categories (A to D below) according to the number of the transmitters and receivers used in the polarization dimension.

A: Single-Input Single-Output (SISO)

Another embodiment of transmission system 10′ according to the present invention is shown schematically in FIG. 8. System 10′ includes an optical OFDM transmitter 30, an optical OFDM receiver 20 and an optical waveguide 52 in the form of an optical fiber that provides an optical link with PMD/PDL, for Coherent Optical Orthogonal Frequency Division Multiplexing (CO-OFDM) transmission. Optical OFDM transmitter 30 includes a Radio Frequency (RF) OFDM transmitter and an OFDM RF-to-optical up-converter; optical OFDM receiver 20 includes an OFDM optical-to-RF down-converter and an RF OFDM receiver. In a direct up/down conversion architecture, an optical I/Q modulator can be used as the up-converter and a coherent optical receiver including an optical 90° hybrid and a local laser (coherent light source) can be used as the down-converter. Suitable architectures for the OFDM up/down converters may be found in Tang et al., IEEE Photon. Technol. Lett 19, 483-485 (2007) which is incorporated herein by reference.

SISO configurations are susceptible to polarization mode coupling in fiber 52, analogous to the multi-path fading impairment in SISO wireless systems. A polarization controller is employed optically before receiver 20 to align the input signal polarization with the local oscillator polarization. More importantly, in the presence of large PMD, owing to the polarization rotation between subcarriers, even the polarization controller may not function well, as there is no uniform subcarrier polarization with which the local receiver laser can align its polarization. Consequently, coherent optical SISO-OFDM is susceptible to polarization-induced fading.

B: Single-Input Two-Output (SITO)

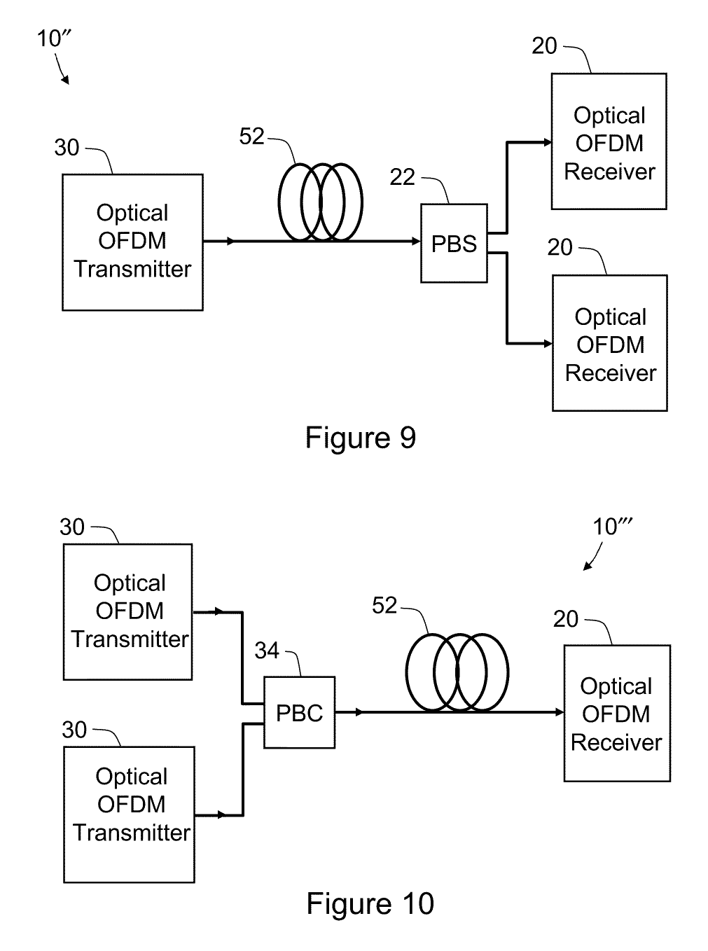

FIG. 9 is a view of another embodiment of a transmission system 10″ according to the present invention. At the transmission end, only one optical OFDM transmitter 30 is used. Though generally comparable to the SISO system of FIG. 8, transmission system 10″ has a polarization beamsplitter 22 and two optical OFDM receivers 20, one for each polarization. Consequently, there is no need for optical polarization control using physical optical components. Furthermore, the effect of PMD on CO-OFDM transmission is a subcarrier polarization rotation, which can be treated through channel estimation and constellation reconstruction. Therefore, coherent optical SITO-OFDM is resilient to PMD when the polarization-diversity receiver 20 is used, and the introduction of PMD in fiber 52 in fact improves the system margin against PDL-induced fading.

C: Two-Input Single-Output (TISO)

A transmission system 10′″ according to another embodiment of the present invention is shown schematically in FIG. 10. System 10′″—although generally comparable to system 10′ of FIG. 8—includes two optical OFDM transmitters 30, one for each polarization, and a combiner 34, but only one optical OFDM receiver 20. This configuration is called polarization-diversity transmitter. By configuring the transmitted OFDM information symbols properly, the CO-OFDM transmission can be performed without a need for a polarization controller at the receiver. One possible transmission scheme is polarization-time coding (PT-coding) as follows.

At the transmitter, the same OFDM symbol is repeated in two consecutive OFDM symbols with orthogonal polarizations. Mathematically, the two consecutive OFDM symbols, for example 2i-1 and 2i, with orthogonal polarization in the form of Jones vector are given by

\vec{c}₂ᵢ₋₁=(cₓⁱ,c_{y}ⁱ)^{t}, \vec{c}₂ᵢ=(−c_{y}ⁱ*,cₓⁱ*)^{t} (9)

The polarization of the subcarriers in two consecutive OFDM symbols are orthogonal by examining the inner product of these two vectors, that is

(\vec{c}₂ᵢ₋₁)^{t}·\vec{c}₂ᵢ*=0 (10)

To simplify the receiver architecture, only one polarization of the received signal, along the polarization of the local laser, is detected in the receiver. Without loss of generality, we assume that the polarization of the local laser is x-polarization. Substituting eq. (9) into eq. (6), assuming phase compensation is performed and denoting H=e^{jΦ}_{_{D}}^{(f}_{ₖ}⁾·Tₖ , the two received OFDM symbols \vec{c}₂ᵢ₋₁′ and \vec{c}₂ᵢ′ are respectively given by

c₂ᵢ₋₁^{x}′=Hₓₓcₓⁱ+H_{xy}c_{y}ⁱ+nₓ²ⁱ⁻¹ (11a)

c₂ᵢ^{x}′=−Hₓₓc_{y}ⁱ*+H_{xy}cₓⁱ*+nₓ²ⁱ (11b)

Solving (11a) and (11b), the \vec{c}₂ᵢ₋₁ can be recovered as

$$\begin{matrix}{\vec{c}}_{2 i - 1} = {H}^{′} \cdot ( {( {c}_{2 i - 1}^{x} {c}_{2 i}^{{x}^{*}} )}^{t} + {( {n}_{2 i - 1}^{x} {n}_{2 i}^{{x}^{*}} )}^{t} ) & ( 12 ) \\ {H}^{′} = {( \begin{matrix}{H}_{xx} & {H}_{xy} \\ {H}_{xy}^{*} & - {H}_{xx}^{*}\end{matrix} )}^{- 1} & ( 13 )\end{matrix}$$

The superscript ‘−1’ stands for the matrix inversion. From eq. (12), it follows that estimated OFDM symbol for ĉ₂ᵢ₋₁ is given by

ĉ₂ᵢ₋₁=H′·(c₂ᵢ₋₁^{x} c₂ᵢ^{x}*)^{t} (14)

The two elements of ĉ₂ᵢ₋₁ in eq. (14) are de-mapped to nearest constellation points to obtain the estimated/detected symbols. This PT-coding is equivalent to Alamouti coding for the space-time coding in wireless systems.

PT-coding may suggest that TISO has the same performance as SITO. However, in the TISO scheme, the same information symbol is repeated in two consecutive OFDM symbols, and subsequently the electrical and optical efficiency is reduced by half, and the OSNR requirement is doubled, compared with the SITO scheme.

D: Two-Input Two-Output (TITO)

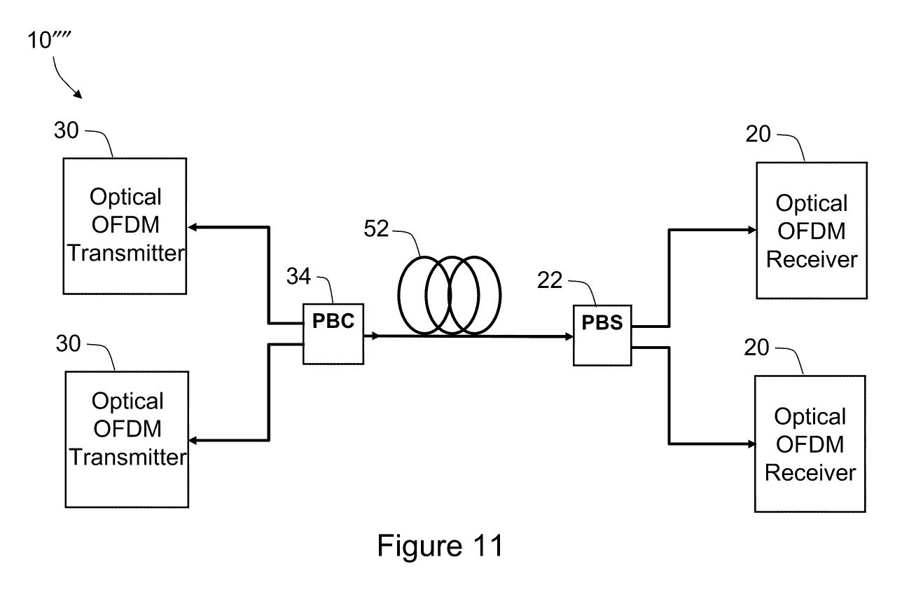

According to still another embodiment of the present invention, a transmission system 10″″ is shown in FIG. 11, having both a polarization-diversity transmitter 30 and a polarization-diversity receiver 20, and referred to as the TITO scheme. Firstly, in such a scheme, because the transmitted OFDM information symbol \vec{c}ᵢₖ can be considered as polarization modulation or polarization multiplexing, the capacity is thus doubled compared with SITO scheme. As the effect of the PMD is to rotate the subcarrier polarization, and can be treated with channel estimation and constellation reconstruction, the doubling of the channel capacity will not be affected by PMD. Secondly, owing to the polarization-diversity receiver employed at the receive end, the TITO scheme may not need polarization tracking at receiver 20.

Channel Estimation and Constellation Reconstruction are Now Described.

In regards to channel estimation, the channel matrix H can be estimated by launching a plurality of known OFDM symbols, each having a different polarization. For simplicity, we use the example of signal processing for one subcarrier. The received and transmitted data symbol of the two polarizations in the forms of Jones vector are given by

\vec{c}′=(c′ₓ c′_{y})^{t} (15)

Assume the fiber transmission Jones Matrix H=e^{jΦ}_{_{D}}^{(f}_{ₖ}⁾·Tₖ, is

$$H = ( \begin{matrix}{h}_{xx} & {h}_{xy} \\ {h}_{yx} & {h}_{yy}\end{matrix} ) \qquad ( 16 )$$

The two received scalar OFDM symbols c′ₓ and c′_{y} after the phase estimation and compensation are

$$\{ \begin{matrix}{c}_{x}^{′} = {h}_{xx} {c}_{x} + {h}_{xy} {c}_{y} + {n}_{x} \\ {c}_{y}^{′} = {h}_{yx} {c}_{x} + {h}_{yy} {c}_{y} + {n}_{y}\end{matrix} \qquad ( 17 )$$

where nₓ and n_{y} are the random noises for two polarizations, and cₓ and c_{y} are the transmitted symbols.

Training symbols are generated by sending orthogonal polarizations for odd and even symbols. Using odd training symbols and ignoring the noise term in (17) for simplicity, channel estimation can be expressed as

$$( \begin{matrix}{c}_{x}^{′} \\ {c}_{y}^{′}\end{matrix} ) = ( \begin{matrix}{h}_{xx} & {h}_{xy} \\ {h}_{yx} & {h}_{yy}\end{matrix} ) ( \begin{matrix}{c}_{x} \\ 0\end{matrix} ) ⇒ \{ \begin{matrix}{h}_{xx} = {c}_{x}^{′} / {c}_{x} \\ {h}_{yx} = {c}_{y}^{′} / {c}_{x}\end{matrix} \qquad ( 18 )$$

and using even training symbols as

$$\{ \begin{matrix}{h}_{xy} = {c}_{x}^{′} / {c}_{y} \\ {h}_{yy} = {c}_{y}^{′} / {c}_{y}\end{matrix} \qquad ( 19 )$$

Equations (18) and (19) demonstrate that the full channel estimation of H can be obtained by using alternative polarization training symbols. Using multiple pilot symbols may improve the accuracy of the channel estimation by, for example, taking average of (18) and (19) cross multiple of the OFDM symbols. It is noted that for optimal performance, the magnitude of the cₓ and c_{y} is set to be \sqrt{2} of that of the data pilot subcarriers.

In regards to constellation reconstruction, from equation (18), the transmitted data symbols can be recovered from the received signals by inverting H:

$$\vec{c} = {H}^{′} ( \begin{matrix}{c}_{x}^{′} \\ {c}_{y}^{′}\end{matrix} ) + {H}^{′} ( \begin{matrix}{n}_{x} \\ {n}_{y}\end{matrix} ) , {H}^{′} = {( \begin{matrix}{h}_{xx} & {h}_{xy} \\ {h}_{yx} & {h}_{yy}\end{matrix} )}^{- 1} \qquad ( 20 )$$

Subsequently the estimated transmitted symbol, ĉ is given by

$$\hat{c} = ( \begin{matrix}{\hat{c}}_{x} \\ {\hat{c}}_{y}\end{matrix} ) = {H}^{′} ( \begin{matrix}{c}_{x}^{′} \\ {c}_{y}^{′}\end{matrix} ) \qquad ( 21 )$$

Once the H′ (inverse rotation of the Jones matrix of H, which is itself another Jones matrix) is obtained through channel estimation, and received OFDM symbol c′ₓ and c′_{y} are recovered. ĉₓ and ĉ_{y} are the estimated transmitted symbols encoded onto the two polarizations and will be subsequently de-mapped to the nearest constellation points to recover the transmitted symbols.

From the above analysis in the framework of CO-MIMO-OFDM models, all the schemes (with the exception of SISO) are capable of polarization-supported transmission. However, as has been discussed, the TISO scheme has penalties in spectral efficiency (electrical and optical) and OSNR sensitivity. Consequently, SITO and TITO OFDM transmission are examples of better configurations.

An Example of Polarization-Supported CO-OFDM Transmission

By using polarization-diversity detection and OFDM signal processing on the two-element OFDM information symbols at the receiver, record PMD tolerance with CO-OFDM transmission has been demonstrated experimentally. In particular, a CO-OFDM signal at 10.7 Gb/s was successfully recovered after 900 ps differential-group-delay (DGD) and 1000-km transmission through SSMF fiber 52 without optical dispersion compensation. The transmission experiment with higher-order PMD further confirms the resilience of the CO-OFDM signal to PMD in the transmission fiber 52, at least for some embodiments. The nonlinearity performance of an example polarization-supported transmission was also observed. For the first time, nonlinear phase noise mitigation based on the receiver 20 digital signal processing has been experimentally demonstrated for one example of CO-OFDM transmission. This was done without any additional optical polarization controller before receiver 20.

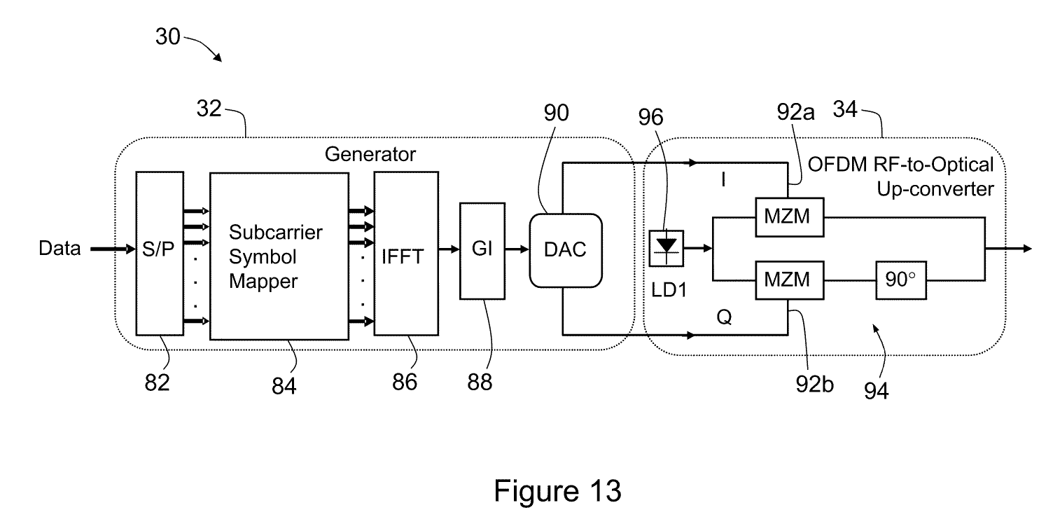

FIG. 13 is a schematic view of a transmitter 30 according to an embodiment of the invention, suitable for use in the systems of FIGS. 1, 6 and 8 to 11. Transmitter 30 includes a generator 32 and a combiner in the form of a OFDM RF-to-optical up-converter 34 comprising an optical I/Q Mach-Zenhder modulator. Generator 32 includes a serial-to-parallel converter 82, a subcarrier symbol mapper 84, an inverse fast Fourier transform module 86, a guard interval inserter 88 and a digital-to-analogue converter (DAC) 90. Generator 32 maps the data bits into each OFDM symbol with subcarrier symbol mapper 84, which are subsequently converted into the time domain with inverse fast Fourier transform module 86, and inserted with a guard interval with guard interval inserter 88. The OFDM digital waveform of s(t) (eq. (1)) is complex. Its real and imaginary parts are uploaded into DAC 90, and two-channel analogue signals representing the real and imaginary components of the complex OFDM signal are generated synchronously. These two signals are fed into I and Q 92a,92b ports of the Mach-Zenhder modulator 94, to perform direct up-conversion of OFDM baseband signals from the RF domain to the optical domain. Mach-Zenhder modulator 94 modulates coherent light from a laser 96 of up-converter 34.

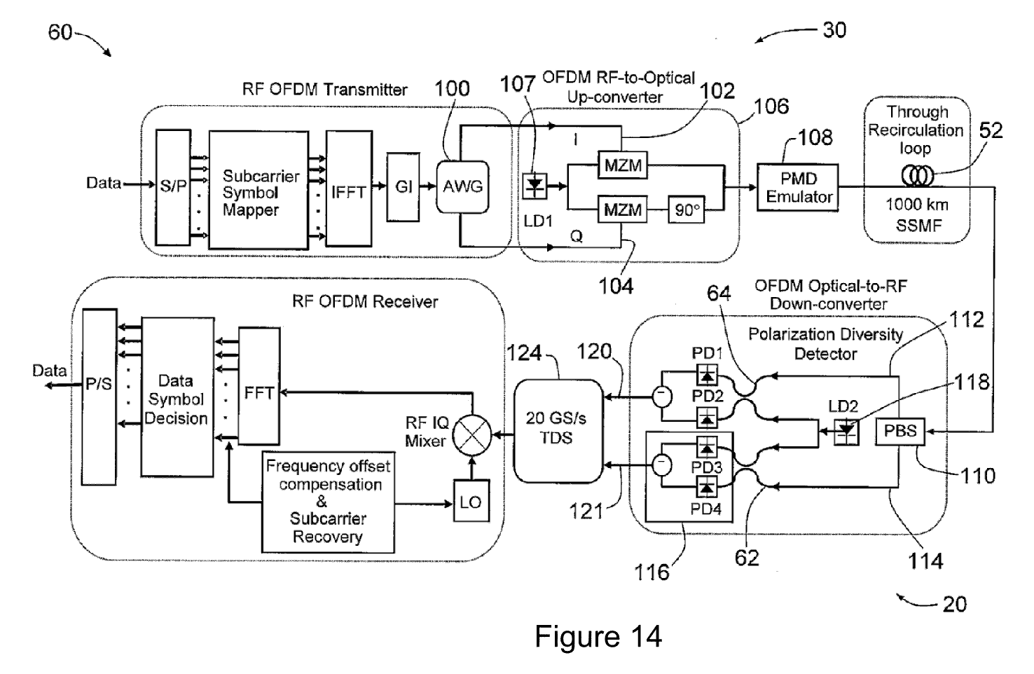

FIG. 14 is a schematic view of an experimental setup 60 for verifying the polarization-supported CO-OFDM systems equivalent of SITO MIMO-OFDM architecture. At the transmit end 30, the OFDM signal is generated by using a Tektronix Arbitrary Waveform Generator (AWG) 100 as an RF OFDM transmitter. The time domain waveform is first generated with a Matlab program including mapping 2¹⁵−1 PRBS into corresponding 77 subcarriers with QPSK encoding within multiple OFDM symbols, which are subsequently converted into the time domain using IFFT, and inserted with guard interval (GI). The number of OFDM subcarriers is 128 and guard interval is ⅛ of the observation period. Again, only the middle 87 subcarriers out of 128 are filled, from which 10 pilot subcarriers are used for phase estimation, to achieve tighter spectral control by over-sampling (as discussed above). The BER performance is measured using all the 77 data bearing channels. The real and imaginary parts of the OFDM digital waveform of s(t) are uploaded into AWG 100 operated at 10 GS/s, and two-channel analogue signals representing the real and imaginary components of the complex OFDM signal are generated synchronously. The so-generated OFDM waveform carries 10.7 Gb/s data. These two signals are fed into I 102 and Q 104 ports of an optical I/Q Mach-Zenhder modulator 106, to perform direct up-conversion of OFDM baseband signals from the RF domain to the optical domain. Modulator 106 modulates coherent light from a laser 107.

The optical OFDM signal from I/Q modulator 106 is first inserted into a home-built PMD emulator 108, and then fed into a recirculation loop 52 which includes one span of 100 km SSMF fiber and an EDFA to compensate the loss. This is the first experimental demonstration of the direct up-conversion with an optical I/Q modulator for a CO-OFDM system. The advantages of such a direct up-conversion scheme are (i) the required electrical bandwidth is less than half of that of intermediate frequency (IF) counterpart, and (ii) there is no need for an image-rejection optical filter. The launch power into each fiber span is set at −8 dBm to avoid inducing optical nonlinearities, and the received OSNR is 14 dB after 1000 km transmission. At the receive end 20, polarization-diversity detection is employed. The output optical signal from the loop is first split into two optical signals 112,114 that are initially orthogonally polarised by a polarizing beam splitter 110. Each split optical signal is guided along a waveguide, such as an optical fibers 62,64. As the split optical signals 112,114, which are initially orthogonally polarized, travel down their respective optical fibers 62, 64 they may lose their orthogonality. Indeed, the polarizations may be scrambled by the optical fibers 62, 64. The split optical signals are each fed into an OFDM optical-to-RF down-converter that includes a balanced receiver such as 116 and a local laser 118 emitting coherent light. RF signals 120,121, each corresponding to a respective polarization, are then input into a Tektronix Time Domain-sampling Scope (TDS) 124 and acquired synchronously. The RF signal traces corresponding to the 1000-km transmission are acquired at 20 GS/s and processed with a Matlab program as an RF OFDM receiver. The RF OFDM receiver signal processing involves (1) FFT window synchronization using Schmidl format to identify the start of the OFDM symbol, (2) software down-conversion of the OFDM RF signal to base-band by a complex pilot subcarrier tone, (3) phase estimation for each OFDM symbol, (4) channel estimation in terms of Jones vector and Jones Matrix, and (5) constellation construction for each carrier and BER computation. Using an optical I/Q modulator for direct up-conversion significantly reduce the electrical bandwidth. The polarization diversity detection used eliminates the need for an optical polarization controller before the coherent receiver.

Measurement Results and Discussion on PMD Tolerance

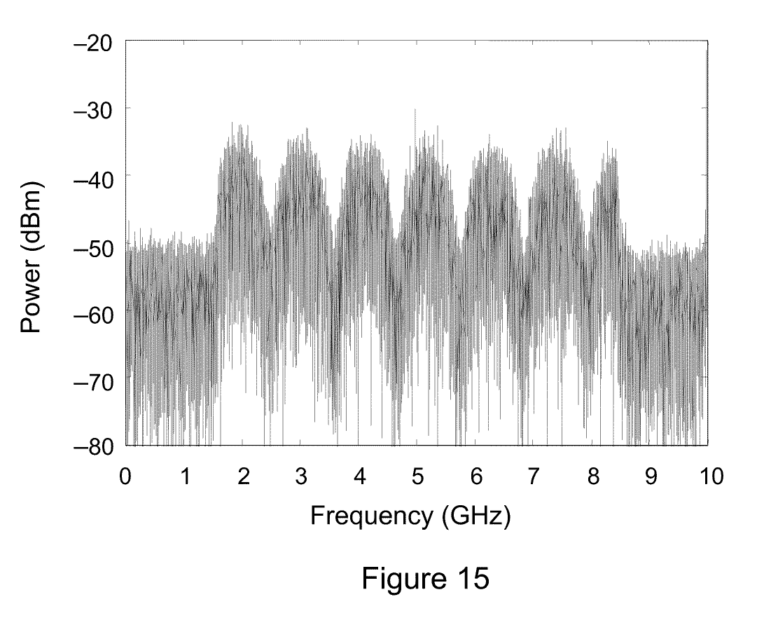

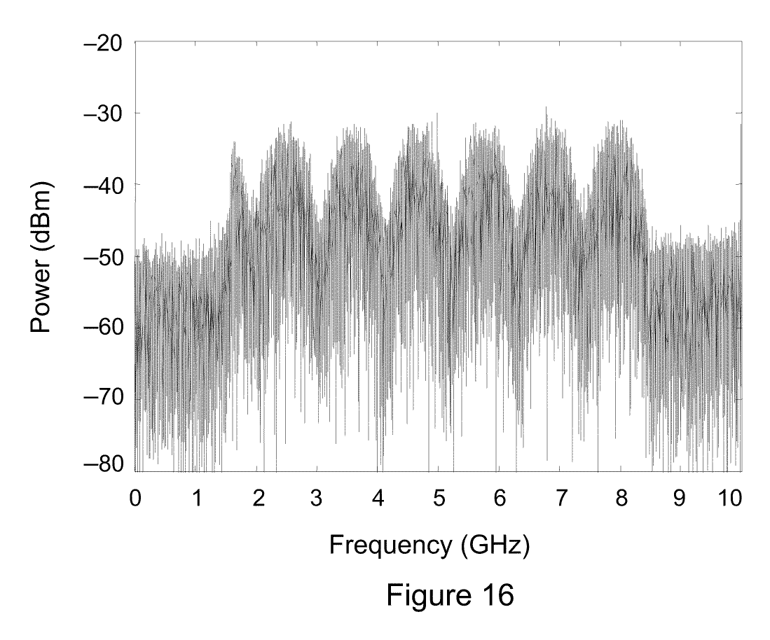

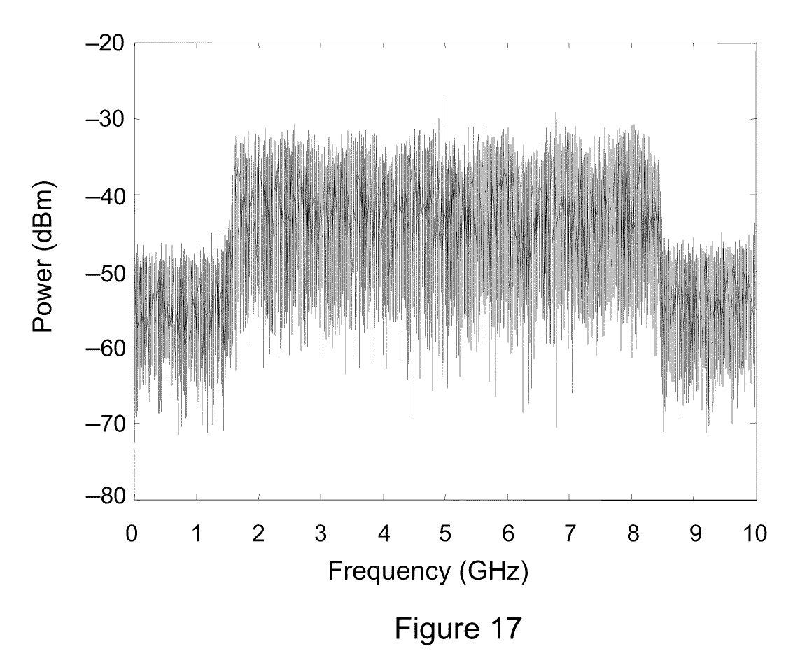

FIGS. 15 and 16 show RF spectra for the two polarization components at the output of the two balanced receivers. This is for a CO-OFDM signal which has traversed 900 ps DGD and 1000 km SSMF fiber. The spectra are obtained by performing a FFT on the signal traces from the coherent detector acquired with the TDS. The periodic power fluctuation of the RF spectra with the period of 1.09 GHz represents the polarization rotation cross the entire OFDM spectrum. This agrees with the 900 ps DGD used in the experiment. FIG. 17 shows the summation of the two power spectra, which effectively recovers the power spectrum for a single-polarization OFDM signal. This signifies that despite the fact that the polarization of each OFDM subcarrier is rotated, but the overall energy for the two polarization components is conserved.

The RF OFDM signals (as shown in FIGS. 15 and 16) are down-converted to baseband by simply multiplying a complex residual carrier tone in software, eliminating a need for a hardware RF LO. This complex carrier tone may be supplied with the pilot symbols or pilot subcarriers. The down-converted baseband signal is segmented into blocks of 400 OFDM symbols with the cyclic prefix removed, and the individual subcarrier symbol in each OFDM symbol is recovered by using FFT.

The suitable receiver signal processing procedure for a polarization-supported system is disclosed in Shieh, IEEE Photon. Technol. Lett 19 134-136 (2006), which is incorporated herein by way of reference. The associated channel model after removing the phase noise φᵢ is given by:

\vec{c}′ₖᵢ^{p}=Hₖcₖᵢ+\vec{n}ₖᵢ^{p} (16)

where \vec{c}′ₖᵢ^{p} is the received OFDM information symbol in a Jones vector for kth subcarrier in the ith OFDM symbol, with the phase noise removed, Hₖ=e^{jΦ}_{_{D}}^{(f}_{ₖ}⁾·Tₖ is the channel transfer function, and \vec{n}ₖᵢ^{p} is the random noise.

The expectation values for the received phase-corrected information symbols \vec{c}′ₖᵢ^{p} are obtained by averaging over a running window of 400 OFDM symbols. The expectation values for 4 QPSK symbols are computed separately by using received symbols \vec{c}′ₖᵢ^{p}, respectively. An error occurs when a transmitted QPSK symbol in particular subcarrier is closer to the incorrect expectation values at the receiver.

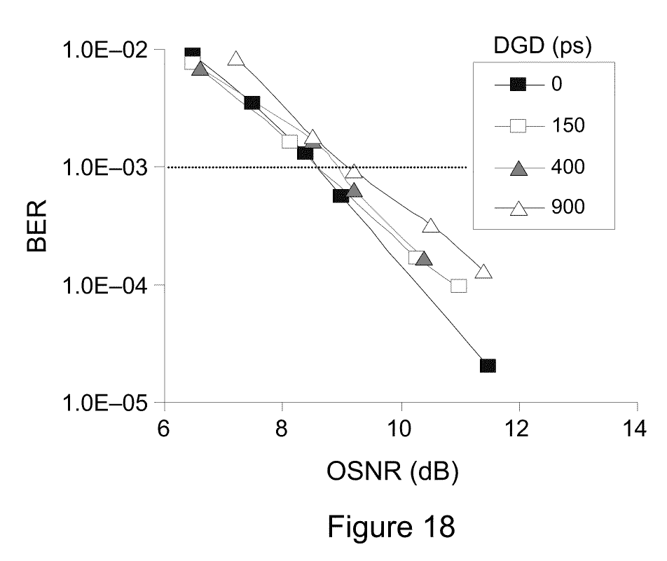

FIG. 18 shows the BER performance of the CO-OFDM signal after 900 ps DGD and 1000-km SSMF transmission. The optical power is evenly launched into the two principal states of the PMD emulator. The measurements using other launch angles show insignificant differences. Compared with the back-to-back case, it has less than 0.5 dB penalty at the BER of 10⁻³. The DGD of 900 ps appears to be the largest DGD tolerance for 10 Gb/s systems yet obtained. The magnitude of the PMD tolerance is shown to be independent of the data rate.

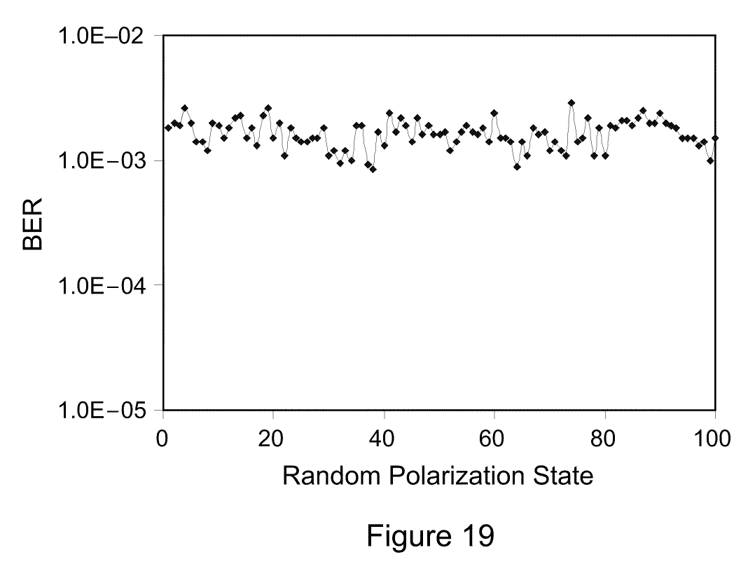

Each OFDM subcarrier can be considered as a flat channel experiencing a local first-order DGD. Since the first-order DGD does not present any impairment to the CO-OFDM signal as shown in FIG. 18, it may be shown that neither does the higher-order PMD. To have a convincing proof of the polarization-supported transmission, we construct a higher-order PMD by inserting a 110 ps DGD emulator into the recirculation loop, and subsequently the output signal of 1000-km simulates a 10-stage PMD cascade, equivalent to a mean PMD over 300 ps. The emulator does not cover all the PMD states of a mean PMD of 300 ps, so the polarization in the fiber was changed randomly and the BER degradation after transmission recorded. FIG. 19 shows the BER fluctuation for 100 random realizations of high PMD states. The BER was initially set to be 10⁻³ without PMD. These realizations were shown to have high DGD along with large higher-order PMD. Despite that, it can be seen in FIG. 19 that the BER shows insignificant degradation.

Nonlinearity Performance of Polarization-Supported CO-OFDM Transmission

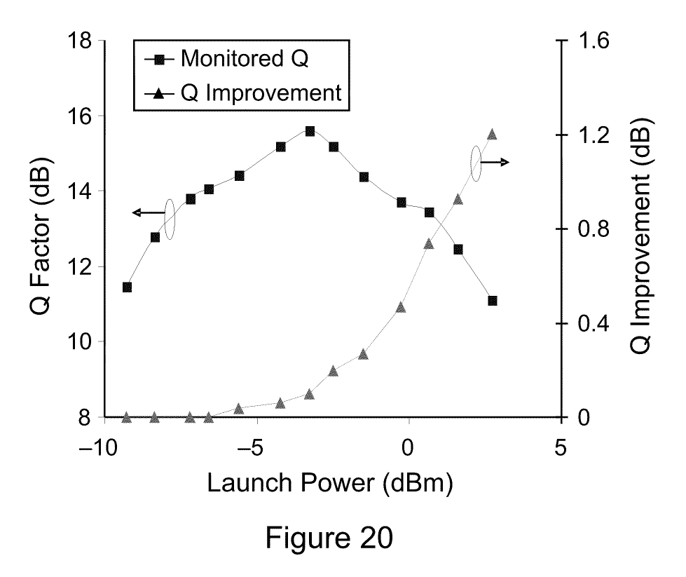

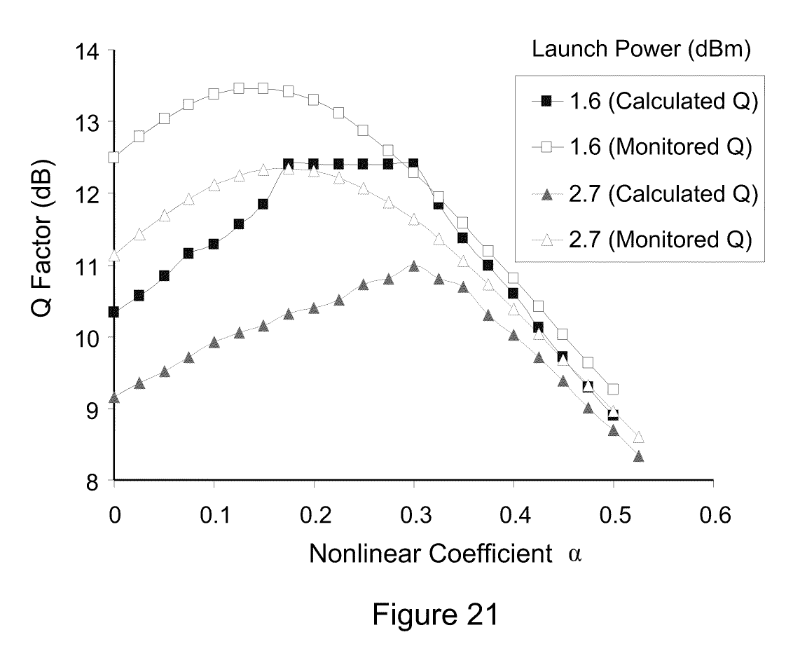

The above discussion is limited to a launch power of −8 dBm where the nonlinearity is insignificant. As in any transmission system, there exists an optimal launch power beyond which the system Q starts to decrease as the input power increases. It is of interest to identify the optimal launch power and the achievable Q for the polarization-supported system. An experimental nonlinearity analysis was performed for the polarization-supported transmission using an embodiment of the setup shown in FIG. 14. The measurement was conducted for a 10.7 Gb/s CO-OFDM signal passing through 900 ps DGD and 1000 km SSMF transmission. FIG. 20 shows the measured system Q as a function of the launch power (the curve with square). It can be seen that the optimal power is about −3.5 dBm with an optimal Q of 15.6 dB. Because of the limited number of OFDM symbols processed in the experiment, the Q factor from direct bit-error-ratio (BER) measurement is limited to 12 dB. Beyond that, a monitoring approach based upon the electrical SNR is used to estimate the Q factor, namely, the Q factor shown in FIG. 20 is the monitored Q. Specifically, the Q factor estimated by using the electrical SNR was termed the monitored Q, and the Q factor obtained by direct actual bit-error-ratio (BER) the calculated Q. Furthermore it was found that at high launch powers the monitored Q deviates from the calculated Q whereas at the low launch powers, the monitored Q agrees with the calculate Q. In particular, at the launch power of 2.7 dBm, the monitored Q is 11.1 dB whereas the actual calculated Q is 9.2 dB, about 2 dB over estimation of Q in high nonlinear regime.

The nonlinearity due to high launch power can be partially mitigated through receiver digital signal processing. The OFDM time domain signal at the receiver s(t) can be expressed as

$$\begin{matrix}s ( t ) = ( \begin{matrix}{s}_{x} \\ {s}_{y}\end{matrix} ) = {s}_{0} ( t ) exp ( j {φ}_{NL} ) & ( 22 ) \\ {φ}_{NL} = {NL}_{eff} γ {\vert s \vert}^{2} = β {I}_{0} {\vert \tilde{s} \vert}^{2} = α {\vert \tilde{s} \vert}^{2} , {\vert s \vert}^{2} ≡ ( {\vert {s}_{x} \vert}^{2} + {\vert {s}_{y} \vert}^{2} ) & ( 23 )\end{matrix}$$

where s_{x/y} is the x/y component of the received optical signal, φ_{NL} is the nonlinear phase noise, N is the number of spans, s₀(t) is the optical field with the optical nonlinearity removed, L_{eff}/γ is the effective length/nonlinear coefficient of the fiber, |s|²≡(|sₓ|²+|s_{y}|²) is the total time-varying optical signal power, I₀= [symbol] |s|² [symbol] is the average of the received optical power, and |\tilde{s}|²≡|s|²/I₀ is the normalized received signal power, β≡NL_{eff}γ is the lumped nonlinearity coefficient, α≡βI₀ is a unitless and different representation of the nonlinear coefficient. The receiver signal processing is as follows. At the signal acquisition and initialization phase, an optimal β is estimated, for instance, based upon BER minimization. Then the nonlinearity mitigated field s₀(t) is obtained as

s₀(t)=s(t)exp(−jβ|s(t)|²) (24)

s₀(t) is subsequently used for OFDM digital processing to recover data. This phenomenological nonlinear coefficient β is estimated without knowing what the detailed dispersion map of the fiber link is, so it is expected that eq. (24) is an approximation and the nonlinear phase noise impact is only partially removed.

The data points shown as triangles in FIG. 20 show the improvement of the monitored Q as a function of the launch power after the nonlinear phase noise compensation (see eq. (24)). These data show that the monitored Q can be improved by as much as 1 dB at high launch powers. Because of the significant disparity between the monitored Q and calculated Q values, the nonlinearity mitigation performance was conducted for both the monitored Q and the calculated Q, as a function of the α parameter at high launch powers of 1.6 dBm and 2.7 dBm. It can be seen that, for the launch power of 1.6 dBm (solid square data points), the improvement of the calculated Q is more than 2 dB, and the optimal α coefficient is about 0.25. The flat top shape of the curve is a result of the best BER that can be achieved by a limited number of OFDM symbols. Similarly, at the launch power of 2.7 dBm, the improvement of the calculated Q is about 2 dB, and the optimal α coefficient is about 0.3. The 2 dB Q improvement is significant, considering only very small additional computation complexity needed to perform the nonlinear phase mitigation (eq. (24)). This 2 dB Q improvement can be also translated into 2 dB dynamic range improvement for the launch power. FIG. 20 also shows that the optimal a coefficient (or β coefficient) is different for the monitored Q and the calculated Q, indicating that the calculated Q (or BER) should be used for optimal nonlinear phase noise mitigation. It should be noted that this is the first experimental demonstration of receiver based nonlinearity mitigation in CO-OFDM systems without optical dispersion compensation.

Now that embodiments have been described, it will be appreciated that some embodiments may have some of the following advantages:
Optical transmission substantially beyond 100 Gbit/s, possibly up to 400 Gbit/s, may be achieved.
Optical signals that are resilient against one or more of polarization and chromatic effects and optical non-linearity within the optical fiber transmission line are produced and detected;
Resilience against PMD of any order is provided;
Optical signals that can propagate further without regeneration (except amplitude regeneration) are produced;
The need for one or more of PMD, CD or optical non-linearity monitoring and/or ameliorating components is reduced, and in some cases eliminated;
The system margin against PDL-induced fading is improved;
Using direct up-conversion (i) requires less electrical bandwidth than the intermediate frequency counterpart and (ii) eliminates the need for an image rejection optical filter;
Reusing old installed fiber which may have large PMD values, is possible;
The PMD resilience for CO-OFDM is independent of data rate, and our experimental demonstration can be potentially scaled to a higher speed system, only limited to the state-of-art electronic signal processing capability;
The polarization-diversity scheme performance is independent of the incoming polarization without a need for a dynamically-controlled polarization-tracking device, which is impractical for field applications;
A polarization controller is not needed at the receiver end.
Polarisation multiplexing, roughly doubling capacity, can be used because of the effective compensation of the polarisation effects.

It will be appreciated that numerous variations and/or modifications may be made to the invention as shown in the specific embodiments without departing from the spirit or scope of the invention as broadly described. The present embodiments are, therefore, to be considered in all respects as illustrative and not restrictive.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in any country.

1. A method comprising:
splitting a received optical signal into split optical signals, the split optical signals being at least initially orthogonally polarized;
coherently detecting at least one of the split optical signals and generating an electrical signal indicative thereof; and
processing said electrical signal, the processing being adapted for received optical signals with orthogonal frequency division multiplexing (OFDM) modulation.

2. A method as claimed in claim 1, including coherently detecting a plurality of said split optical signals and generating respective electrical signals indicative thereof, and processing said electrical signals.

3. A method as claimed in claim 2, including processing all of said electrical signals, the processing being adapted for received optical signals with OFDM modulation.

4. A method as claimed in claim 3 wherein the processing comprises at least partial compensation for degradation due to polarisation.

5. A method as claimed in claim 1, wherein splitting the received optical signal comprises splitting the received optical signal into at least initially linearly polarized optical signals.

6. A method as claimed in claim 4, wherein processing comprises constructing a Jones vector of a received OFDM symbol.

7. A method as claimed in claim 6, wherein processing comprises determining an estimated Jones matrix.

8. A method as claimed in claim 7, comprising rotating the Jones vector by the Jones matrix.

9. A method as claimed in claim 8, comprising demapping each element of the Jones vector into a respective digital bit.

10. A method as claimed in claim 1, wherein processing at least one electrical signal comprises channel estimation.

11. A method as claimed in claim 10, wherein channel estimation comprises exploiting a Jones vector and a Jones matrix.

12. A method as claimed in claim 1, comprising estimating a transmitted information symbol using a received Jones vector multiplied by an inverse of an estimated channel transfer function Jones matrix.

13. A method as claimed in claim 1, further comprising a preliminary step of generating the received optical signal, the optical signal having OFDM modulation.

14. A method as claimed in claim 13, wherein generating the received optical signal comprises combining two other optical signals having orthogonal polarizations.

15. A method comprising:
generating a pair of optical signals, each of the optical signals having Orthogonal Frequency Division Multiplexing (OFDM) modulation; and
combining the pair of optical signals in a polarization domain.

16. A method as claimed in claim 15, wherein said modulation is performed by an optical I/Q-modulator biased at null, driven by a complex Orthogonal Frequency Division Multiplexing (OFDM) modulation signal.

17. A receiver comprising:
a polarization splitter for splitting a received optical signal into split optical signals, the split optical signals being at least initially orthogonally polarized;
one or more coherent optical detectors for coherently detecting at least one of the split optical signals and generating an electrical signal indicative thereof; and
a processor for processing said electrical signal, the processing being adapted for received optical signals with Orthogonal Frequency Division Multiplexing (OFDM) modulation.

18. A receiver as claimed in claim 17, wherein the polarization splitter is arranged to split the received optical signal into at least initially linearly polarized optical signals.

19. A receiver as claimed in claim 17, wherein the one or more coherent optical detectors comprise:
a combiner for combining one of the split optical signals with a coherent light; and
a photo-detector for detecting the combination.

20. A receiver as claimed in claim 17, comprising an optical 90° hybrid, a local coherent light source, and a plurality of single-ended or balanced photo-detectors.

21. A receiver as claimed in claim 17, wherein the processor is arranged for channel estimation of at least one electrical signal.

22. A receiver as claimed in claim 17, wherein the processor is arranged to exploit a Jones vector and a Jones matrix.

23. A transmitter comprising:
a generator for generating a plurality of optical signals, each of the optical signals having Orthogonal Frequency Division Multiplexing (OFDM) modulation; and
a combiner for combining the plurality of optical signals.

24. A transmission system comprising:
a transmitter comprising:
a generator for generating a plurality of optical signals, each of the optical signals having Orthogonal Frequency Division Multiplexing (OFDM) modulation; and
a combiner for combining the plurality of optical signals; and
a receiver comprising:
a polarization splitter for splitting a received optical signal into split optical signals, the split optical signals being at least initially orthogonally polarized;
one or more coherent optical detectors for coherently detecting at least one of the split optical signals and generating an electrical signal indicative thereof; and
a processor for processing said electrical signal, the processing being adapted for received optical signals with Orthogonal Frequency Division Multiplexing (OFDM) modulation.

25. A transmission system comprising:
a generator for generating an optical signal having Orthogonal Frequency Division Multiplexing (OFDM) modulation; and
a receiver comprising:
a polarization splitter for splitting a received optical signal into split optical signals, the split optical signals being at least initially orthogonally polarized;
one or more coherent optical detectors for coherently detecting at least one of the split optical signals and generating an electrical signal indicative thereof; and
a processor for processing said electrical signal, the processing being adapted for received optical signals with Orthogonal Frequency Division Multiplexing (OFDM) modulation.
